(19) United States
(12) Patent Application Publication
(10) Pub. No.: US 2007/0227995 A1
(43) Pub. Date: Oct. 4, 2007

(54) Davit assembly

(75) Inventors: Scott C. Casebolt, St. Paul Park, MN (US); Travis P. Betcher, Goodhue, MN (US); J. Thomas Wolner, Red Wing, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/396,295

(22) Filed: Mar. 31, 2006

(51) Int. Cl. B66C 23/18

(52) U.S. Cl. 212/179

(57) ABSTRACT

A davit assembly comprises a leg having an inner portion and an outer portion, a base, a support, and an arm. The inner portion has a first end and a second end, and the outer portion has a third end and a fourth end. The first end and the third end are secured to one another, and the inner portion extends partially along the length of the outer portion. The second end is proximate a middle portion of the outer portion. The base includes a cavity, and the first end and the third end are secured to the base. The bushing is incorporated into the cavity of the base. The support has a bottom end and a top end, the bottom end being rotatable within the bushing and connectable to the base. The arm is operatively connected to the top end of the support.

### FIELD OF THE INVENTION

The present invention relates to a davit assembly.

### BACKGROUND OF THE INVENTION

Various occupations place people in precarious situations thereby creating a need for safety equipment and rescue equipment. For example, a person may fall down or become injured while working in a confined space that is accessible via a small opening such as a manhole. In another possible scenario, a person may fall off the edge of a cliff or become injured while working proximate the face of the cliff. In yet another possible scenario, a person may require work positioning or suspension equipment to assist in performing tasks. As a result, it is often desirable to provide an anchorage structure for supporting a cable that extends downward into a manhole, down the face of a cliff, or other precarious situation and is capable of withstanding forces associated with arresting a person's fall, raising a person being rescued, or positioning/suspending a person performing tasks. One such anchorage structure is a davit assembly.

### SUMMARY OF THE INVENTION

In one aspect of the invention, a davit assembly comprises a leg, a base, a bushing, a support, and an arm. The leg has an inner portion and an outer portion, the inner portion being shorter in length than the outer portion. The inner portion has a first end and a second end, and the outer portion has a third end and a fourth end. The first end and the third end are secured to one another, and the inner portion extends partially along the length of the outer portion. The second end is proximate a middle portion of the outer portion. The base includes a cavity, and the first end and the third end are secured to the base. The bushing is incorporated into the cavity of the base. The support has a bottom end and a top end, the bottom end being rotatable within the bushing and connectable to the base. The arm is operatively connected to the top end of the support.

In another aspect of the invention, a davit assembly comprises at least three legs, a base, at least three spokes, a support, and an arm. Each of the at least three legs has an inner portion and an outer portion. The inner portion is shorter in length than the outer portion. The inner portion has a first end and a second end, and the outer portion has a third end and a fourth end. The first end and the third end are secured to one another, and the inner portion extends partially along the length of the outer portion. The second end is proximate a middle portion of the outer portion. The base includes a cavity, and the at least three spokes extend outward from the base. The cavity is between the at least three spokes. A leg is secured to each spoke. The first end and the third end of each leg are secured to each respective spoke. The inner portion and the outer portion of each leg provide additional strength proximate the base. The support has a bottom end and a top end, the bottom end being connectable to the base. The arm is operatively connected to the top end of the support.

In another aspect of the invention, a davit assembly comprises at least three legs, a base having a cavity, a bushing molded into the cavity of the base, a support, and an arm. The at least three legs are connected to the base, and the cavity is between the at least three legs. The bushing is integral with the base. The support has a bottom end and a top end, the bottom end being connectable to the base. The arm is operatively connected to the top end of the support.

Another aspect of the invention is a method of making a davit assembly. A bushing is molded into a cavity of a base, and the bushing is integral with the base. An inner portion is inserted into an outer portion. The inner portion has a shorter length than the outer portion. The inner portion has a first end and a second end, and the outer portion has a third end and a fourth end. The first end of the inner portion and the third end of the outer portion are connected to the base. The second end of the inner portion extends to proximate a middle portion of the outer portion. The inner portion and the outer portion provide additional strength proximate the base. A support is inserted into the cavity, and the support is rotatable within the bushing and connectable to the base. The support is connected to the base.

### BRIEF DESCRIPTION OF THE DRAWINGS

FIG. 1 is a side perspective view of a davit assembly constructed according to the principles of the present invention;

FIG. 2 is a top view of the davit assembly shown in FIG. 1;

FIG. 3 is a partial exploded top perspective view of a base and legs of the davit assembly shown in FIG. 1;

FIG. 4 is a cross section of a leg of the davit assembly shown in FIG. 1;

FIG. 5 is a top view of the base shown in FIG. 3;

FIG. 6 is a side view of the base shown in FIG. 5;

FIG. 7 is a cross section taken along the lines 7-7 shown in FIG. 6; and

FIG. 8 is a side view of the davit assembly shown in FIG. 1 in a folded, closed position.

### DETAILED DESCRIPTION OF A PREFERRED EMBODIMENT

A preferred embodiment davit assembly constructed according to the principles of the present invention is designated by the numeral 100 in the drawings.

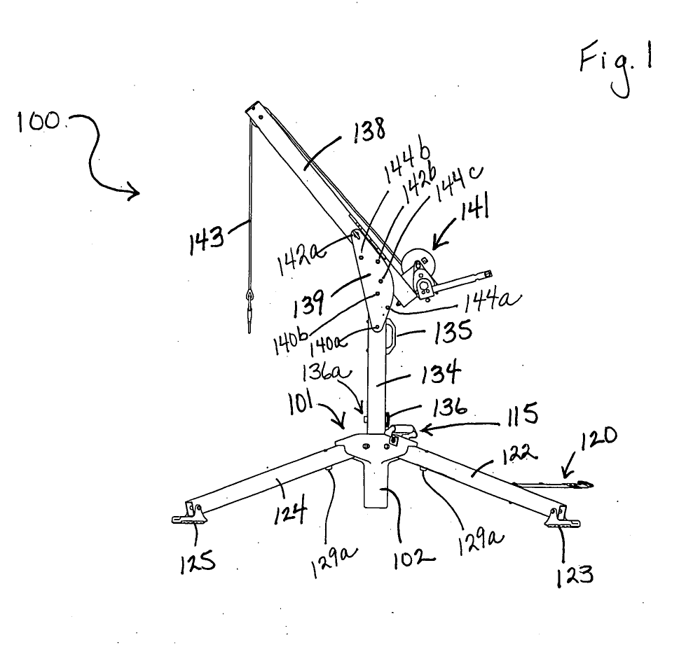

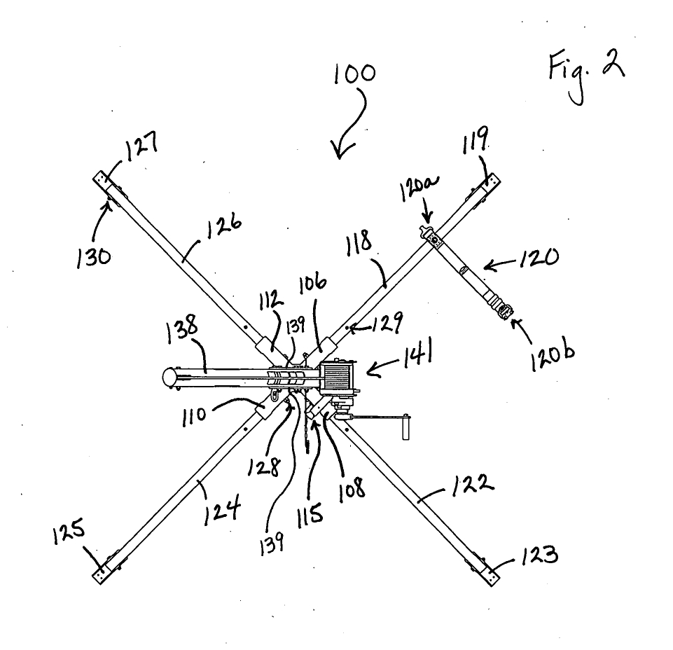

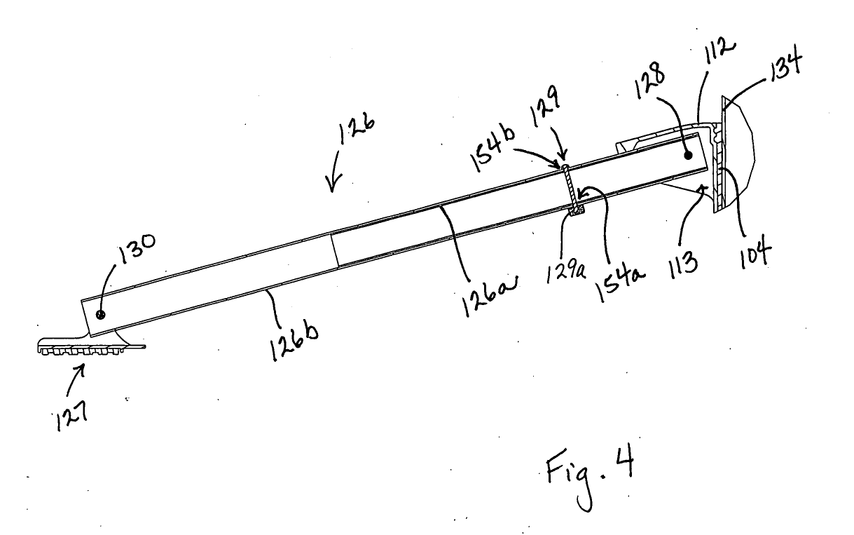

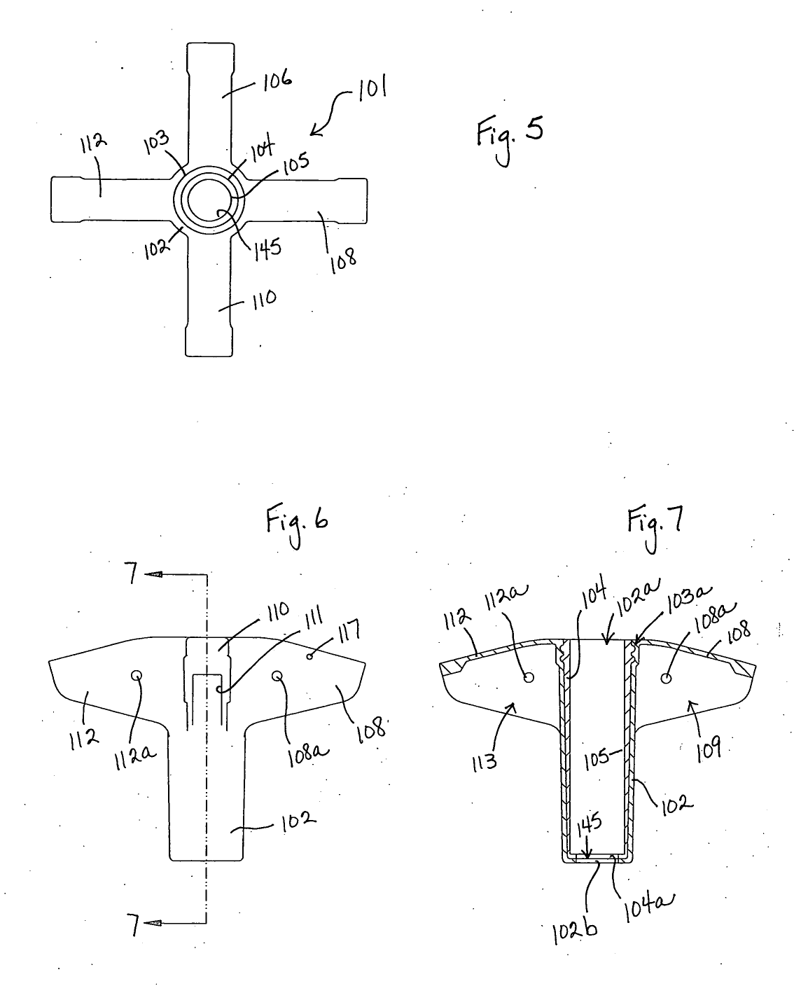

The davit assembly 100 generally includes a base 101, a support 134, and a davit arm 138 as shown in FIG. 1. The base 101 includes a support receiving portion 102 which is preferably a hollow cylindrical tube with a cavity such as a vertically extending bore 103 with an opening 102a proximate the top of the base 101 providing access to the cavity. The base 101 is shown in more detail in FIGS. 5-7. Within the bore 103 of the support tube 102 proximate the top of the base 101 are preferably two detents 103a, which are more preferably circumferential grooves, but it is recognized that any suitable receptacle may be used. The bore 103 is configured and arranged to retain a bushing 104 having a bore 105, and the bore 105 is configured and arranged to receive an end of the support 134. Thus, the support 134 is supported by the support receiving portion 102 and held in the base 101 by gravity. A drainage hole 145, formed by openings 102b and 104a in the support tube 102 and the bushing 104, respectively, may be included in the bottom of the base 011.

The bushing 104 is preferably made of a material with low friction characteristics to minimize the force required to rotate the support 134 within the support receiving portion 102 so that lubrication is not required. Therefore, the support 134 is rotatable within the bushing 104. Preferably, urethane is molded within the bore 103 of the support receiving portion 102. It is recognized that any moldable material suitable for use as a bushing may be molded into the base 101 by molding methods well known in the art. When molded, the bushing 104 fills in the detents 103a so that the bushing 104 is secured within the bore 103 and is therefore integral with the base 101. The bushing 104 is held in place by an interference fit created when the molded bushing fills in the detents 103a within the support tube 102. Other suitable materials such as nylon and other suitable plastics may be molded within the bore 103 of the support receiving portion 102.

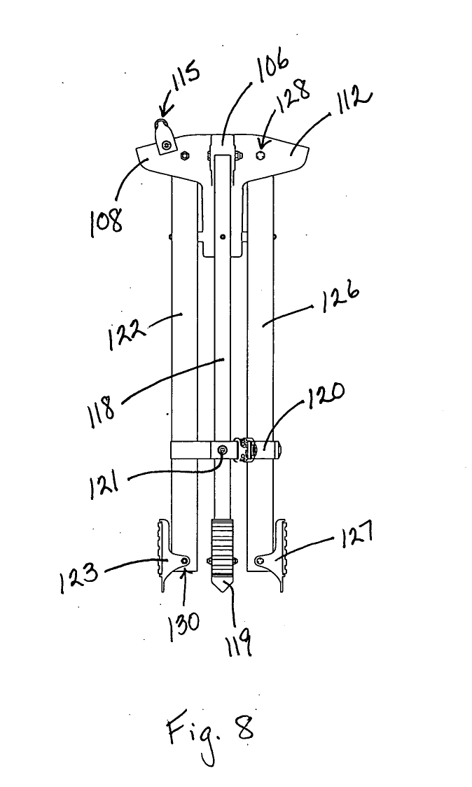

The support receiving portion 102 acts as a hub and a first spoke 106, a second spoke 108, a third spoke 110, and a fourth spoke 112 extend outward radially from the support receiving portion 102. Preferably, the spokes 106, 108, 110, and 112 are approximately ninety degrees from one another with the first spoke 106 and the third spoke 110 extending outward from opposing sides of the support receiving portion 102 and the second spoke 108 and the fourth spoke 112 extending outward from opposing sides of the support receiving portion 102. The first spoke 106 has a first cavity (not shown), the second spoke 108 has a second cavity 109, the third spoke 110 has a third cavity 111, and the fourth spoke 112 has a fourth cavity 113. The spokes are preferably partial cylinders tapered from the top, outer ends downward toward the bottom, inner ends so that the tops and the sides are covered and the outer ends and the bottoms are open. The cavities are accessible from the outer ends and from the bottoms of the spokes as shown in FIG. 7.

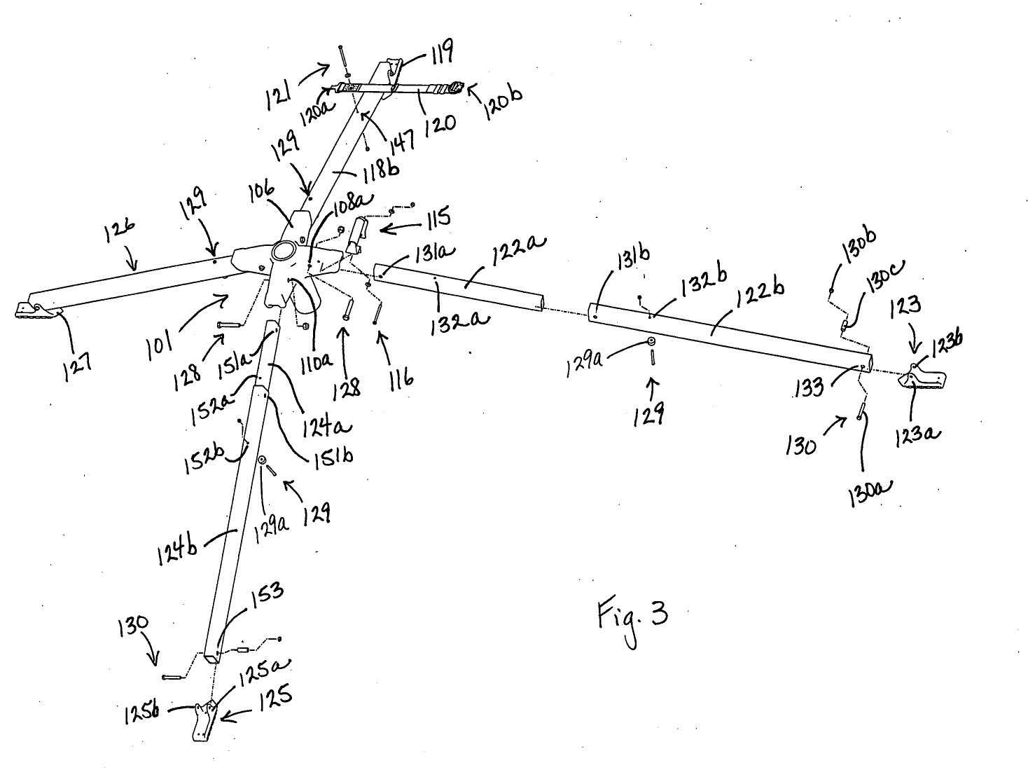

Both sides of the spokes include aligned apertures proximate the support receiving portion 102. As shown in FIGS. 6 and 7, the second spoke 108 includes apertures 108a and the fourth spoke 112 includes apertures 112a. As shown in FIG. 3, the third spoke 110 includes apertures 110a. The first spoke 106 includes similar apertures (not shown). The second spoke 108 also includes aligned apertures 117 proximate the top and the outer end through which a fastener 116 is inserted to connect a handle 115 thereto. The fasteners shown and described herein are preferably bolts secured with nuts and washers may also be used, but it is recognized that any suitable fastener may be used.

A first leg 118 includes an inner portion (not shown) and an outer portion 118b, which are preferably rectangular-shaped tubular members. The inner portion 118a has a smaller height and width than the outer portion 118b so that the inner portion 118a fits inside of the outer portion 118b and extends only partially through the length of the outer portion 118b. The first leg 118 is inserted into the first cavity of the first spoke 106. The inner portion 118a and the outer portion 118b include apertures (not shown) at one end corresponding with the apertures (not shown) in the first spoke 106 through which a fastener 128 is inserted to connect the inner portion 118a and the outer portion 118b to the first spoke 106. The first leg 118 is pivotable about the fastener 128. The inner portion 118a and the outer portion 118b also include apertures (not shown) through which a fastener 129 is inserted to connect a bumper 129a to the inner portion 118a and the outer portion 118b proximate a middle portion of the inner portion 118a. A first foot 119 is operatively pivotally connected to the end of the first leg 118 opposite the end connected to the first spoke 106. Optionally, as shown in FIG. 3, a securing strap 120 having a male buckle 120a at one end and a mating female buckle 120b at the other end is connected to the first leg 118 with a fastener 121 inserted through apertures 147 in the outer portion 118b.

A second leg 122, a third leg 124, and a fourth leg 126 are similar to the first leg 118. Preferably, each of the legs is constructed from two tubular members, an inner portion tube inside of an outer portion tube. The inner portion tube extends only part way from the base 101 toward the foot thereby reducing the weight of each of the legs and providing the desired strength of each of the legs proximate the base 101. The length of the inner portion tube extending within the outer portion tube depends upon the bending moment of the tubular members used for each of the legs. The bending stress is greatest proximate the connection areas of the spokes 106, 108, 110, and 112 with the respective legs 118, 122, 124, and 126. The bending stress is reduced along the length of each of the legs until it reaches nothing at the foot. The inner portion tube must extend far enough within the outer portion tube until the outer portion tube alone can withstand the load. Preferably, the inner portion tube extends approximately ½ to ¾ along the length of the outer portion tube.

The second leg 122 includes an inner portion 122a and an outer portion 122b, which are preferably rectangular-shaped tubular members. The inner portion 122a has a smaller height and width than the outer portion 122b so that the inner portion 122a fits inside of the outer portion 122b and extends only partially through the length of the outer portion 122b. The second leg 122 is inserted into the second cavity 109 of the second spoke 108. The inner portion 122a includes apertures 131a and the outer portion 122b includes aperture 131b at one end corresponding with the apertures 108a in the second spoke 108 through which a fastener 128 is inserted to connect the inner portion 122a and the outer portion 122b to the second spoke 108. The second leg 122 is pivotable about the fastener 128. The inner portion 122a and the outer portion 122b also include apertures 132a and 132b, respectively, through which a fastener 129 is inserted to connect a bumper 129a to the inner portion 122a and the outer portion 122b proximate a middle portion of the inner portion 122a. The outer portion 122b also includes apertures 133 proximate the end of the second leg 122. A second foot 123 is operatively pivotally connected to the end of the second leg 123 opposite the end connected to the second spoke 108. The second foot 123 includes two flanges 123a extending upward proximate one end, and the flanges 123a include apertures 123b corresponding with the apertures 133 of the second leg 122. The second leg 122 fits between the flanges 123a, and a fastener 130 is inserted through the apertures 123b and 133 to connect the second foot 123 to the second leg 122. The fastener 130 includes a bolt 130a, a nut 130b, and a roller 130c to space apart the head of the bolt 130a and the nut 130 to enable the second foot to be pivotable about the fastener 130.

The third leg 124 includes an inner portion 124a and an outer portion 124b, which are preferably rectangular-shaped tubular members. The inner portion 124a has a smaller height and width than the outer portion 124b so that the inner portion 124a fits inside of the outer portion 124b and extends only partially through the length of the outer portion 124b. The third leg 124 is inserted into the third cavity 111 of the third spoke 110. The inner portion 124a includes apertures 151a and the outer portion 124b includes aperture 151b at one end corresponding with the apertures 110a in the third spoke 110 through which a fastener 128 is inserted to connect the inner portion 124a and the outer portion 124b to the third spoke 110. The third leg 124 is pivotable about the fastener 128. The inner portion 124a and the outer portion 124b also include apertures 152a and 152b, respectively, through which a fastener 129 is inserted to connect a bumper 129a to the inner portion 124a and the outer portion 124b proximate a middle portion of the inner portion 124a. The outer portion 124b also includes apertures 153 proximate the end of the second leg 124. A third foot 125 is operatively pivotally connected to the end of the third leg 124 opposite the end connected to the third spoke 110. The third foot 125 includes two flanges 125a extending upward proximate one end, and the flanges 125a include apertures 125b corresponding with the apertures 153 of the third leg 124. The third leg 124 fits between the flanges 125a, and a fastener 130 is inserted through the apertures 125b and 153 to connect the third foot 125 to the third leg 124. The fastener 130 includes a bolt 130a, a nut 130b, and a roller 130c to space apart the head of the bolt 130a and the nut 130 to enable the third foot 125 to be pivotable about the fastener 130.

The fourth leg 126 is shown in FIG. 4 and includes an inner portion 126a and an outer portion 126b, which are preferably rectangular-shaped tubular members. The inner portion 126a has a smaller height and width than the outer portion 126b so that the inner portion 126a fits inside of the outer portion 126b and extends only partially through the length of the outer portion 126b. The fourth leg 126 is inserted into the fourth cavity 113 of the fourth spoke 112. The inner portion 126a and the outer portion 126b include apertures (not shown) at one end corresponding with the apertures 112a in the fourth spoke 112 through which a fastener 128 is inserted to connect the inner portion 126a and the outer portion 126b to the fourth spoke 112. The fourth leg 126 is pivotable about the fastener 128. The inner portion 126a and the outer portion 126b also include apertures 154a and 154b, respectively, through which a fastener 129 is inserted to connect a bumper 129a to the inner portion 126a and the outer portion 126b proximate a middle portion of the inner portion 126a. A fourth foot 127 is operatively pivotally connected to the end of the fourth leg 126 opposite the end connected to the fourth spoke 112.

The support 134 is preferably a cylindrical post with one end connected to the base 101. The support 134 is held in a vertical position by the base 101 and by gravity, and the support 134 may be rotated about the vertical axis during use to swing a worker out from above a hole during rescue of the worker. Two opposing support brackets 139 interconnect the top end of the support 134 and the davit arm 138. Preferably, the support brackets 139 are generally triangular in shape. A fastener 140a connects a bottom portion proximate a vertex of the support brackets 139 to the support 134, and a fastener 140b connects a middle portion of the support brackets 139 to the support 134. Preferably, the fastener 140a is a removable detent pin. A fastener 142a connects a top portion proximate another vertex of the support brackets 139 to the davit arm 138, and a fastener 142b connects a middle portion of the support brackets 139 to the davit arm 138. A fastener 144a extends through the support brackets 139 proximate the side of the support 134 and the top of a handle 135 and acts as a stop against the side of the support 134. Fasteners 144b and 144c extend through the support brackets 139 proximate the bottom of the davit arm 138 and act as a stop against the bottom of the davit arm 138. The handle 135 is preferably connected to the support 134 below the support bracket 139. A winch assembly 141 is connected to one end of the davit arm 138 proximate the support bracket 139 and a cable 143 of the winch assembly 141 extends along the davit arm 138 to the opposite end of the davit arm 138. The support 134, the support bracket 139, the davit arm 138, and the winch assembly 141 are shown for illustrative purposes only as any suitable substitute components may be used.

When not in use, the davit assembly 100 may be placed in a folded, closed position. The support 134 is removed from the base 101, the fastener 140a is removed from the support 134 and the support brackets 139, and the support 134 is pivoted about fastener 140b toward the support brackets 139 and the davit arm 138. A fastener (not shown) may be operatively connected to the support 134 proximate the bottom portion of the support 134 and used to secure a strap 136 with mating buckles much like the securing strap 120 with mating buckles 120a and 120b secured with fastener 121. The strap 136 may be used to secure the davit arm 138 to the support 134 during storage of the davit assembly 100. The fastener (not shown) may also connect a bumper 136a to the side of the support 134 opposite the strap 136 which prevents the support 134 from contacting the davit arm 138. The legs 118, 122, 124, and 126 pivot about the fasteners 128 downward relative to the base 101, and the securing strap 120 is used to secure the legs 118, 122, 124, and 126 in the folded, closed position as shown in FIG. 8. The bumpers 129a prevent the legs 118, 122, 124, and 126 from contacting the support tube 102. The bumpers 129a and 136a provide gaps between the legs 118, 122, 124, and 126 and the support tube 102 and between the support 134 and the davit arm 138, respectively, to help prevent pinching of fingers. The support 134 may be carried by the handle 135, and the base 101 may be carried by the handle 115.

In operation, the securing strap 120 is released and the legs 118, 122, 124, and 126 are pivoted upward toward the base 101. The tops of the spokes 106, 108, 110, and 112 prevent the respective legs from pivoting upward beyond the spokes. Preferably, the legs pivot approximately 75 degrees between the tops of the spokes and the support tube 102. The feet 119, 123, 125, and 127 pivot about fasteners 130 to level the legs 118, 122, 124, and 126 upon a support surface. The strap 136 is released and the support 134 is pivoted about fastener 140b away from the davit arm 138, and the fastener 140a is inserted through the support brackets 139 and the support 134 to secure the support 134 to the support brackets 139. The bottom end of the support 134 is inserted into the bore 103 and secured in a vertical orientation and held in place by gravity. The bushing 104 allows the support post 134 to be easily rotated to position and reposition the davit arm 138. The davit arm 138 is adjusted as is known in the art.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A davit assembly, comprising:
a) a leg having an inner portion and an outer portion, the inner portion being shorter in length than the outer portion, the inner portion having a first end and a second end, the outer portion having a third end and a fourth end, the first end and the third end being secured to one another, the inner portion extending partially along the length of the outer portion, the second end being proximate a middle portion of the outer portion;
b) a base to which the leg is secured including a cavity, the first end and the third end being secured to the base;
c) a bushing incorporated into the cavity of the base;
d) a support having a bottom end and a top end, the bottom end being rotatable within the bushing and connectable to the base; and
e) an arm operatively connected to the top end of the support.

2. The davit assembly of claim 1, wherein at least three legs are secured to the base.

3. The davit assembly of claim 2, wherein the base includes at least three spokes extending outward from the base, the cavity being between the at least three spokes, the first end and the third end of each leg being secured to each respective spoke and each respective leg extending outward from the base.

4. The davit assembly of claim 1, wherein the second end extends a distance of approximately ½ to ¾ along the length of the outer portion.

5. The davit assembly of claim 1, wherein the bushing is molded into the cavity of the base and is integral with the base.

6. The davit assembly of claim 5, wherein the bushing is made from a material selected from the group consisting of urethane and nylon.

7. The davit assembly of claim 1, wherein the cavity of the base is a bore.

8. A davit assembly, comprising:
a) at least three legs, each leg having an inner portion and an outer portion, the inner portion being shorter in length than the outer portion, the inner portion having a first end and a second end, the outer portion having a third end and a fourth end, the first end and the third end being secured to one another, the inner portion extending partially along the length of the outer portion, the second end being proximate a middle portion of the outer portion;
b) a base including a cavity;
c) at least three spokes extending outward from the base, the cavity being between the at least three spokes, a leg secured to each spoke, the first end and the third end of each leg being secured to each respective spoke, the inner portion and the outer portion of each leg providing additional strength proximate the base;
d) a support having a bottom end and a top end, the bottom end being connectable to the base; and
e) an arm operatively connected to the top end of the support.

9. The davit assembly of claim 8, further comprising a bushing molded into the cavity of the base and being integral with the base.

10. The davit assembly of claim 9, wherein the bushing is made from a material selected from the group consisting of urethane and nylon.

11. The davit assembly of claim 9, wherein the bottom end of the support is rotatable within the bushing.

12. A davit assembly, comprising:
a) at least three legs;
b) a base having a cavity, the at least three legs being connected to the base, the cavity being between the at least three legs;
c) a bushing molded into the cavity of the base and being integral with the base;
d) a support having a bottom end and a top end, the bottom end being connectable to the base; and
e) an arm operatively connected to the top end of the support.

13. The davit assembly of claim 12, wherein the bushing is made from a material selected from the group consisting of urethane and nylon.

14. The davit assembly of claim 12, further comprising a detent within the cavity of the base, the bushing being molded to fill in the detent thereby securing the bushing to the base in the cavity.

15. A method of making a davit assembly, comprising:
a) molding a bushing into a cavity of a base, the bushing being integral with the base;
b) inserting an inner portion into an outer portion, the inner portion having a shorter length than the outer portion, the inner portion having a first end and a second end, the outer portion having a third end and a fourth end;
c) connecting the first end of the inner portion and the third end of the outer portion to the base, the second end of the inner portion extending to proximate a middle portion of the outer portion, the inner portion and the outer portion providing additional strength proximate the base;
d) inserting a support into the cavity, the support being rotatable within the bushing and connectable to the base; and
e) connecting the support to the base.

16. The method of claim 15, further comprising connecting at least three legs to the base.

17. The method of claim 15, wherein the bushing is made from a material selected from the group consisting of urethane and nylon.
